(19) United States
(12) Patent Application Publication
(10) Pub. No.: US 2009/0237209 A1
(43) Pub. Date: Sep. 24, 2009

(54) Communicating keychain

(76) Inventors: Brian William Seal, Fon Do Luc, WI (US); Lori Ann Mondt, Fond Du Luc, WI (US)

Correspondence Address: Brian Seal, 412 Grove Street, Fond du Luc, WI, 54935, US

(21) Appl. No.: 12/381,752

(22) Filed: Mar. 16, 2009

Related U.S. Application Data
(60) Provisional application No. 61/070,359, filed on Mar. 20, 2008.

(51) Int. Cl. H04Q 1/30

(52) U.S. Cl. 340/7.21

(57) ABSTRACT

One embodiment of communication between a device that holds one or more keys and a cellular device like but not limited to a cellphone or personal digital assistant. The communication can include a method of locating one device with the other, controlling one device with the other by remote, displaying information of one to the other, and communication either audible, visual, or physical through vibration to the user of the devices. The communication between the devices is wireless and should not be limited.

### CROSS-REFERENCE TO RELATED APPLICATIONS

This application claims the benefit of provisional patent application Ser. No. 61,070,359 filed 2008 Mar. 3 by inventor Brian W Seal. Provisional patent application

### FEDERALLY SPONSORED RESEARCH

Not applicable.

### SEQUENCE LISTING OR PROGRAM

To be developed.

### BACKGROUND

1. Field of Invention

This invention relates to the field of communication, specifically communication between a keychain device and cell phone.

2. Conception

The conception of this invention was at a family get together at Lori Mundt's house. We were talking about patents because of a patent I was working on at the time. At that time Lori Mundt said she had an idea of a phone that could call lost keys to find them. At that time I thought it could work the other way around also. After thinking about it for a few days and discussing it with Lori, I filed the idea as a cellular concept in a provisional patent application to protect a date of conception

### PRIOR ART

Cell phones have been around for years, and now bluetooth technology is advancing rapidly. It would be very easy to convert a blue tooth device for holding keys. Or basically fit a key ring on to a bluetooth type device. I know years ago my mother had had a keychain that she could find by whistling and then the key chain would beep, however in my patent search I was unable to find any such device. Our invention would be substantialy different because it is not a keychain that you would find by a person making a noise but rather communication between a cell phone and a keychain. Yes it would enable you to find a keychain that is lost, however the keychain would also be able to find a lost cell phone and other communication would be able to take place. The invention is not so much for finding lost keys as it is the communication that takes place between a cellular device and a cellular, “Bluetooth or radiofrequency” keychain device. There are also keychain devices that can lock and unlock a car door. There are keychain devices that have panic buttons and there are keychain devices that can enable or disable an alarm system. There are keychain or key ring bottle openers. There are key rings that hold photos. None of these devices I know of can communicate with a cell phone.

### SUMMARY

In accordance with embodiment 1 a method of communication between a key ring device and a cellular device by means of wireless communication. Communication that can take place between such devices is not limited and the devices should be able to locate each other by remote. The devices should also be able to access each others features and information and even turn each other on or off by remote.

### DRAWINGS

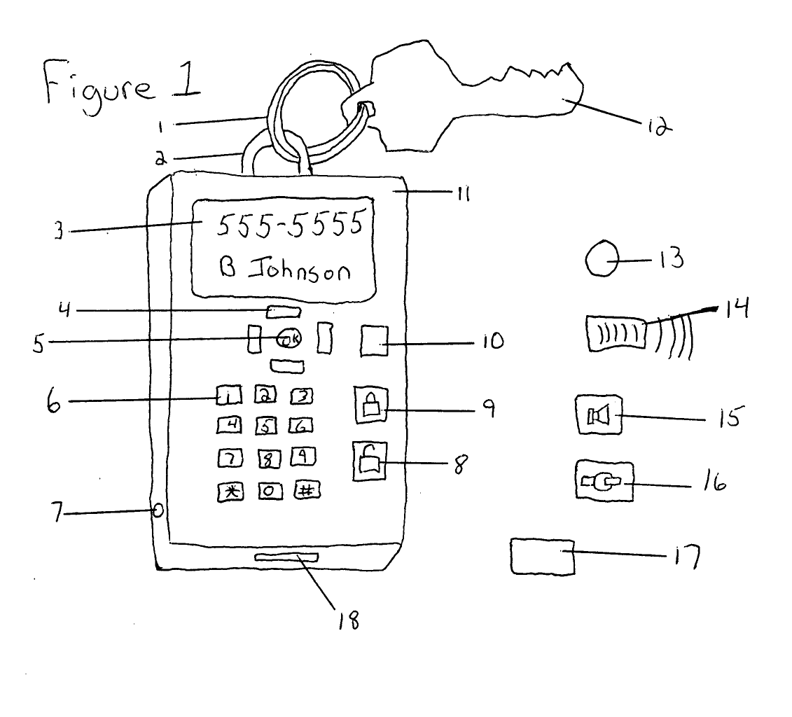

### FIGS. 1-3

There are 3 figures and they are of little importance. I could have drawn and endless supply of figures with different sizes and designs. The three figures are just to give a basic concept of the Invention which is, a new use for wireless communication, a method of locating lost keys or phone, a method of running by remote a cellular device, a method of turning on a cellular device by remote. In most basic terms the Invention is the communication that takes place between a cellular device and a device for holding keys

FIG. 1

1. Shows a key ring. This does not need to be a ring. It could be a chain, or a compartment could be used in place of this, as long as it holds or attaches a key to the wireless device.

2. Shows a means of attaching a ring or chain to the wireless device. It could be made out of any desired material. Plastic, metal, etc.

3. Shows a display screen. The display screen can display any desirable information, however in this case it displays caller Identification sent from the cellular device. It could also display things like but not limited to memory of a cellular device, text messages, battery meter, etc.

4. Is a button that could be used for scrolling or to activate a feature.

5. Another button that could be used for things like but not limited to access to a menu.

6. Shows the number one button on a cellular keypad,

7. Shows a port for charging a battery

8. Shows a lock button for unlocking anything to the remote on the cellular device, a car door or even a house door. Of course the house or car door would also need to be equipped with a wireless communication device capable of communicating with the device that holds keys.

9. Shows a lock button that would work in the opposite way as the button that unlocks desired objects or programs.

10. Shows yet another button that could be used for things like but not limited to sending out a signal to enable a beeper on a lost phone. Or it could be used to turn on a phone by remote.

11. Shows the casing of the wireless keychain device.

12. Shows a key

13. Represents a battery, or source of power. This could be a replaceable or rechargeable battery. This would be located inside the casing.

14. Represents wireless communication. This would be located inside the casing.

15. Represents a means of sound like a speaker or beeper. And could include a means for vibrating. This could be located inside the casing, or plugged in like a head set.

16. Represents a microphone. This could be used for things like but not limited to speaking like a blue tooth device. Or a recording device for such things as personal notes. This could be located inside the device or plugged.

17. Represents a computer program for running any features you would want to add like but not limited to a calculator, calendar, stop watch, clock, etc

18. Represents a data port, or could be used as a port for a head set.

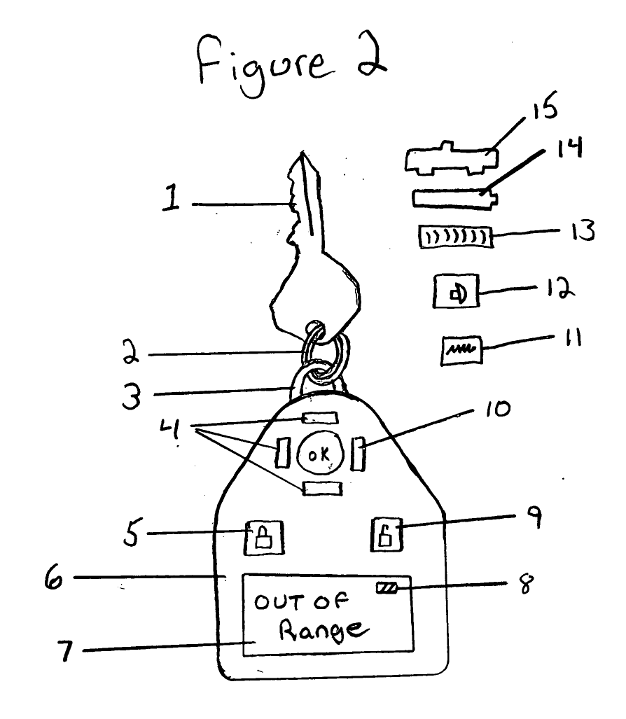

FIG. 2.

FIG. 2 is a simpler device than FIG. 1.

1. Is a key.

2. Is a key ring.

3. Is a means for attaching a key ring or chain.

4. Are scroll or feature buttons.

5. A lock button

6. The casing of the wireless communicator that holds keys.

7. A display screen that is displaying an out of range message. This could mean the cellular device is out of range to communicate with the wireless keychain.

8. Is a battery meter. This is just another of the unlimited things that could be displayed.

9. Is an unlock button.

10. Is another scroll button or feature button.

11. Represents a vibrator that would be located in the wireless keychain device.

12. Represents a means for making sound. It could be a speaker or beeper.

13. Represents a means of wireless communication.

14. Represents a power source.

FIG. 2. Numbers 11 through 14 would be located inside the wireless keychain.

15. Is a battery cover, however it could be the battery itself and act as a cover and battery all in one.

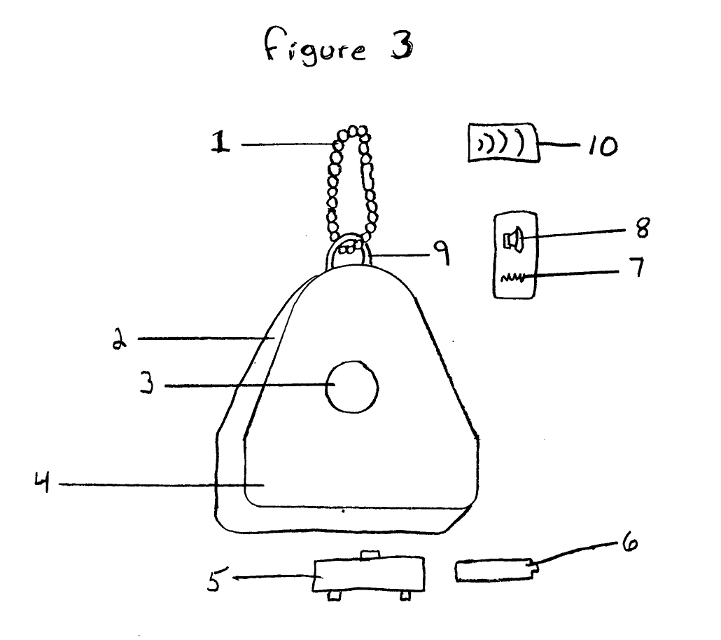

FIG. 3

FIG. 3 is the simplest design of the figures.

1. Shows a chain for keys and attaches to the device through a loop on the casing of the device.

2. Shows the side wall of the casing of the device

3. Shows a button you can press that would activate a signal as a search feature to help you find a lost phone

4. Shows the front casing of the wireless key chain holder.

5. Shows a battery cover, that could also be a battery that attaches to the wireless key chain device.

6. Shows a battery. It could be rechargeable or replaceable.

7. Shows a vibrator that can be added to the phone. This could be used to let you know when your phone rings if it is not in hearing distance or the ringer is off. It need not be added and is an optional feature.

8. Shows a speaker or means of sound that can be added to the device. This could be used to notify you if you have a call coming in on your phone, or to locate your keys if you lose them. Both 7 and 8 would be located inside the wireless keychain.

9. Is a loop for connecting the chain and keys to the wireless device.

10. Is a means of wireless communication to communicate with you phone, or cellular device.

### DETAILED DESCRIPTION EMBODIMENT 1

Embodiment 1 uses wireless communication between a key chain device or key ring device, or any type of key holder and a cellular device like a phone or Blackberry etc. The communication does not have to be any certain kind of wireless communication, as long as its wireless. The key chain device can include a display screen. The key chain device can be used for retrieving information normally displayed on a phone, such as caller identification or text messages. The key ring device can be equipped with a ringer, ring tones or vibrate to let you know when you have an incoming call or message. It could even alert you of an alarm you have programmed on your phone. The key ring device can include any features included on a cell phone or cellular device and should not be limited to theses features. The key ring device could include other features like but not limited to unlocking a car by wireless or setting an alarm system. The key ring device could be used in the same way a blue tooth is used to have a conversation while the phone is at a distance. The key ring device could be used as a communicator to talk with someone that has the cellular device. The key ring device would also be capable of sending information to a phone and can include a keypad for remote operation of the phone. Remote operation of the phone could include thing like but not limited to powering it on, to changing ring tones. Basically the key ring device could control by remote anything you want it to control that the cell phone is capable of. The key ring device can include GPS and track a users lost phone or PDA by a display screen or emitting noise depending on proximity to the phone. The closer you are to the phone it could emit a more intense or more frequent noise. The phone could do the same thing to find a missing key ring. The cellular device can if desired operate the key chain device in the same way that the key ring device can operate the cellular device. This communication between these devices could even be used for a monitoring system like a baby monitor. By adding a feature to the wireless keychain device for unlocking doors on your house or your car, you would in turn be able to unlock either your house or car with your cellular device by operating the keychain device by remote with your cellular device. The communication between theses devices should not be limited.

### Advantages

From the detailed description above, a number of advantages are found in the embodiment for the communication between a wireless device that holds at least one key and a cellular device are evident.

A. The ability to use your key chain device to locate your lost cellular device

B. The ability to use your cellular device to locate your lost keys

C. The ability to power your phone on by remote can help you locate a lost phone you may otherwise not be able to locate as easy.

D. The ability to operate your keychain device by remote from your cellular device would permit you to unlock your house or car that your keys are locked in as long as you have your cellular device.

E. The ability to operate and read your cellular devices information from your key chain device can be handy when your phone is out of reach.

F. The detection of the devices proximity to each other can help you to easily locate either one and even prevent you from leaving either one of them behind.

G. The ability to use these devices as a monitoring system.

### CONCLUSIONS, RAMIFICATIONS AND SCOPE

Accordingly, the reader can see that the wireless communication between a keychain and a cellular device can help those who are constantly misplacing their phone or keys. Further more the communication between these devices has other advantages as listed above. This communication can save time and stress for anyone using it and it creates another way of making life easier in a ever changing hectic world.

Although the description above has many specifications, these should not be construed as limiting the scope of the embodiment but merely providing illustration of some of the embodiments.

Thus the scope of the invention should be determined by the appended claims and their legal equivalents, rather than by examples given.

1. A method of communication between a device that holds at least one key and a cellular device, the improvement being the ability to locate one device with the other device, and, or the ability to transmit information between the devices.

2. Whereas the cellular device in claim 1 can be a cell phone, or personal digital assistant.

3. Where the device that holds at least one key from claim 1 can display information displayed on the cellular device's screen.

4. Whereas the device that holds at least one key from claim 1 can have a display screen that displays information.

5. Whereas the device that holds at least one key from claim 1 can power on a cellular device by remote control.

6. Whereas the device that holds at least one key from claim 1 can control a cellular device's features.

7. Whereas the device that holds at least one key from claim 1 can make sound and or vibrate.

8. Whereas the both devices from claim 1 can emit sounds by remote command according to the proximity of the devices to each other.

9. The device that holds at least one key and the cellular device from claim 1 can notify a person if a predetermined proximity between the devices has occurred.

10. Whereas both the devices from claim 1 can be used as a monitoring system.

11. Whereas the device that holds at least one key from claim one can be equipped with a global positioning system.

12. Whereas the cellular device from claim 1 can operate the keychain device from claim 1 by remote control.

13. Whereas the device that holds at least one key from claim 1 can open locks by remote control.

14. A method of powering on or off a cellular device by remote control.

15. A wireless communication device comprising:
(a) a means of holding at least 1 key,
(b) at least one button for remote control,
(c) a power source,
(d) a means of communication with a user and or a cellular device.
